(19) United States
(12) Patent Application Publication
(10) Pub. No.: US 2006/0238451 A1
(43) Pub. Date: Oct. 26, 2006

(54) Display device

(75) Inventor: Yasunori Higuchi, Chuo-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/393,843

(22) Filed: Mar. 31, 2006

(30) Foreign Application Priority Data
Mar. 31, 2005 (JP) 2005-102775

(51) Int. Cl. G09G 3/28

(52) U.S. Cl. 345/60

(57) ABSTRACT

Disclosed is an image display device that is capable of preventing malfunction of drive sequence control of light emission to enable stable control. The image display device comprises a memory, a control section, and a signal output section. The memory stores a plurality of data sets and the corresponding data flags. The control section reads the data set and the corresponding data flag from the memory in synchronization with a synchronization signal, and determines whether the data set read from the memory is valid based on the corresponding data flag. The signal output section supplies a control signal causing a drive pulse generation circuit to generate the drive pulse having the type of waveform defined by the data set read from the memory, unless the control section determines that the data set is not valid.

### BACKGROUND OF THE INVENTION

1. Field of the Invention

The present invention relates to an image display device such as a plasma display, and particularly to an image display device that enables stabilization of sequence control.

2. Description of the Related Art

A plasma display has a discharge space in which discharge gas is sealed between a front glass substrate and a back substrate which face each other. On an inner surface of the front glass substrate, a plurality of row electrode pairs that are stripe electrodes extending in the row direction are formed. A plurality of column electrodes that extends in the column direction are formed on an inner surface of the back substrate. Each pair of row electrodes represents one display line. A plurality of display cells (i.e., discharge cells) are formed at the respective intersections of the row electrode pairs and the column electrodes, and divide the discharge space into a plurality of areas. Fluorescent material is coated on the inside of each display cell. When images are displayed on the plasma display, wall charges are selectively formed in the display cells and discharge sustaining pulses are repeatedly applied to the display cells through the row electrode pairs. As a result, gas discharges (sustain discharges) are generated in the selected display cells where the wall charges are formed, and produce ultraviolet rays by which the fluorescent material in the display cells are excited to emit light.

As a drive method for the plasma display, a subfield method is widely used. According to the subfield method, one field constituting one image is divided into a plurality of subfields, the ratio of an emission sustaining period in each subfield is set to a power of 2, and multi-grayscale display is performed by using a combination of these subfields. For example, if the ratios of the emission sustaining periods (that is the weight of brightness) of eight subfields SF₁, SF₂, . . . , SF₈ are set to 2⁰:2¹:2²:2³:2⁴:2⁵:2⁶:2⁷, that is, 1:2:4:8:16:32:64:128, then the multi-grayscale display can be performed by the combinations of these subfields.

Each subfield is comprised of, for example, a reset period, address period and discharge sustaining period. During the reset period, erase pulses for erasing the wall charges remaining in the display cells are applied. During the address period, address pulses for selectively forming wall charges in the display cells are applied. During the discharge sustaining period, rectangular discharge sustain pulses are repeatedly applied to all of the display cells so that display cells in which wall charges are selectively formed emit light. The control circuit (not illustrated) that controls a drive sequence for the light emission reads waveform data sets from a non-volatile memory (not illustrated) for the application of pulses during each of the periods, and generates either one of erase pulses, address pulses and discharge sustain pulses at an appropriate timing in accordance with the waveform data set. Technology on the drive sequence control for the light emission is disclosed in, for example, Japanese Patent Application Kokai No. 2003-288042.

The control circuit can control the drive sequence for light emission in accordance with synchronization signals. The control circuit, however, may cause malfunction when an error occurs on a synchronization frequency, or when abnormal multiple interrupts (i.e., when another interrupt is generated during interrupt processing) occurs. In such a case, the control circuit may read undefined data that is different from proper waveform data to be read from the non-volatile memory, and may execute the drive control of the light emission based on the undefined data, thereby causing the malfunction.

### SUMMARY OF THE INVENTION

In view of the foregoing, it is an object of the present invention to provide an image display device that is capable of preventing malfunction of drive sequence control of light emission to enable stable control.

According to one aspect of the present invention, there is provided an image display device comprising a drive pulse generation circuit for generating drive pulses having a plurality of different types of waveforms in synchronization with a synchronization signal corresponding to an image signal; and a display panel including a plurality of display cells, each display cell emitting light in response to the drive pulses. The image display device comprises a memory for storing a plurality of data sets and the corresponding data flags; a control section for reading the data set and the corresponding data flag from the memory in synchronization with the synchronization signal, and determining whether the data set read from the memory is valid based on the corresponding data flag; and a signal output section for supplying a control signal causing the drive pulse generation circuit to generate the drive pulse having the type of waveform defined by the data set read from the memory, unless the control section determines that the data set is not valid.

Further features of the invention, its nature and various advantages will be more apparent from the accompanying drawings and the following detailed description of the preferred embodiments.

### BRIEF DESCRIPTION OF THE DRAWINGS

FIG. 1 is a block diagram depicting a configuration of a plasma display (image display device) according to an embodiment of the present invention;

FIG. 2 is a diagram depicting an example of a drive sequence for light emission;

FIG. 3 is a diagram illustrating storage areas in a memory; and

FIG. 4 is a timing chart illustrating an operation of a sequence control circuit.

### DETAILED DESCRIPTION OF THE INVENTION

Various embodiments of the present invention will now be described.

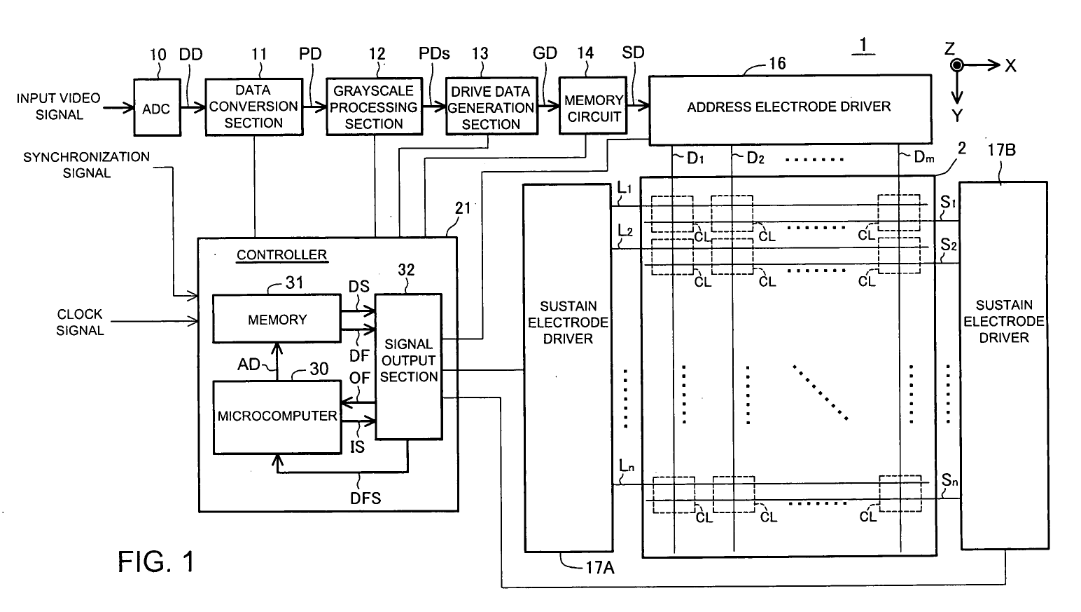

FIG. 1 is a block diagram depicting a configuration of a plasma display (image display device) 1 according to an embodiment of the present invention. The plasma display 1 comprises a display panel (plasma display panel) 2; display cells (discharge cells) CL in the display panel 2; address electrode driver 16 for supplying various drive pulses to CL; and sustain electrode drivers 17A and 17B. The plasma display 1 further comprises an A/D converter (ADC) 10, data conversion section 11, grayscale processing section 12, drive data generation section 13, memory circuit 14 and controller 21. The controller 21 controls the operation of the processing blocks 11, 12, 13, 14, 16, 17A and 17B by using synchronization signals (including horizontal and vertical synchronization signals) supplied from an outside source, and clock signals. The address electrode driver 16 and the sustain electrode drivers 17A and 17B can constitute the drive pulse generation circuit.

The A/D converter 10 generates a digital video signal DD by sampling and quantizing an analog input video signal, and supplies the generated signal to the data conversion section 11. The data conversion section 11 performs inverse gamma conversion on the digital video signal using a predetermined characteristic curve, and supplies a video signal PD to the grayscale processing section 12. The grayscale processing section 12 performs error diffusion processing and dither processing on the video signals PD, and supplies a corrected video signal PDs to the drive data generation section 13.

The drive data generation section 13 generates a drive data signal GD from the corrected video signal PDs, and supplies the signal GD to the memory circuit 14. The memory circuit 14 temporarily stores the supplied drive data signal GD to an internal buffer memory (not illustrated), and also reads the drive data signal stored in the buffer memory in subfield units and supplies the signal to the address electrode driver 16. The address electrode driver 16 generates address pulses based on the field data signal SD supplied from the memory circuit 14, and applies the address pulses to the address electrodes D₁, . . . , Dₘ.

The display panel 2 comprises a plurality of display cells CL which are arranged in a matrix on a plane surface; m number of address electrodes D₁, D₂, . . . , Dₘ (m is 2 or a higher integer) extending in the Y direction from the address electrode driver 16; n number of strip type sustain electrodes L₁, L₂, . . . , Lₙ (n is 2 or a higher integer) extending in the X direction perpendicular to the Y direction from the first sustain electrode driver 17A; and n number of strip type sustain electrodes S₁, S₂, . . . , Sₙ extending in the −X direction from the second sustain electrode driver 17B. In the present embodiment, one address electrode Dₚ (p is an integer in the 1-m range) constitute one column electrode, and two sustain electrodes L_{q} and S_{q} (q is an integer in the 1 to n range) constitutes one row electrode pair, and one display line is formed along each row electrode pair. The address electrode Dₚ and the row electrode pair are separated in the thickness direction of the substrates (not illustrated) of the display panel 2. At intersections of address electrodes D₁, . . . , Dₘ with the row electrode pairs, display cells CL are formed respectively. Each display cell CL has fluorescent material with a predetermined emission color, and a discharge space is formed between the row electrode pairs and the address electrode Dₚ. A number of display cells CL can constitute one pixel cell.

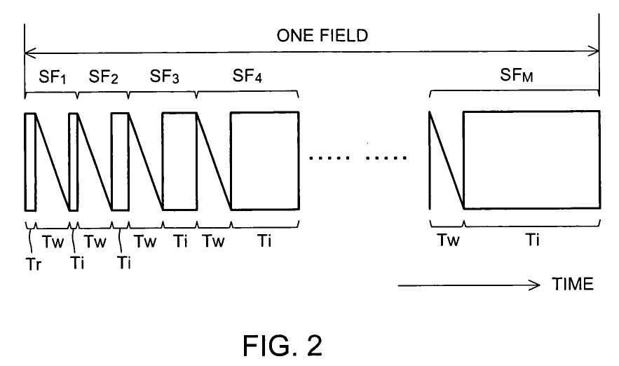

The controller 21 executes drive control of light emission in accordance with a predetermined drive sequence for light emission. FIG. 2 illustrates an example of a drive sequence for light emission. In FIG. 2, one field of display period of a video signal is comprised of a period of M number of subfields SF₁-SF_{M} (M is 2 or a higher integer) which are successively arranged by a sequence for display (during subfield periods). Each of subfields SF₁-SF_{M} has an address period Tw and sustaining period Ti. Only the first subfield SF₁ has a reset period Tr before the address period Tw. The emission sustaining periods Ti, Ti, Ti, . . . , Ti which are in proportion to the respective weights of 2⁰, 2¹, 2², . . . , 2^{M} are assigned to the respective subfields SF₁, SF₂, SF₃, . . . , SF_{M}.

During the reset period Tr of the subfield SF₁, gas discharges are generated in all of the display cells CL, and wall charges are stored in all of the display cells CL. During the address period Tw after the reset period Tr, the sustain electrode driver 17A applies scanning pulses sequentially to the sustain electrodes L₁-Lₙ, and the address electrode driver 16 applies address pulses in synchronization with the scanning pulses, to the address electrodes D₁, . . . , Dₘ. As a result, gas discharges (i.e., erase address discharges) are selectively generated in the display cells CL, and the wall charges are selectively erased. The display cells CL where the wall charges are stored without being erased will emit light during the subsequent sustaining period Ti. During the sustaining period Ti, the sustain electrode drivers 17A and 17B repeatedly apply discharge sustain pulses with opposite polarities to the sustain electrodes L₁, . . . , Lₙ and the sustain electrodes S₁, . . . , Sₙ, respectively, a predefined number of times. As a result, sustain discharges are repeatedly generated in the display cells where the wall charges are stored, and fluorescent material in the display cells CL are excited to emit light. In each of the subsequent subfields SF₁-SF_{M}, gas discharges (i.e., erase address discharges) are generated selectively in the display cells CL and wall charges are selectively erased during the address period Tw. During the sustaining period Ti, sustain discharges are repeatedly generated in the display cells CL where the wall charges are stored a number of times assigned to the subfield. By the above drive sequence for light emission, M+1 gray scales of display are enabled.

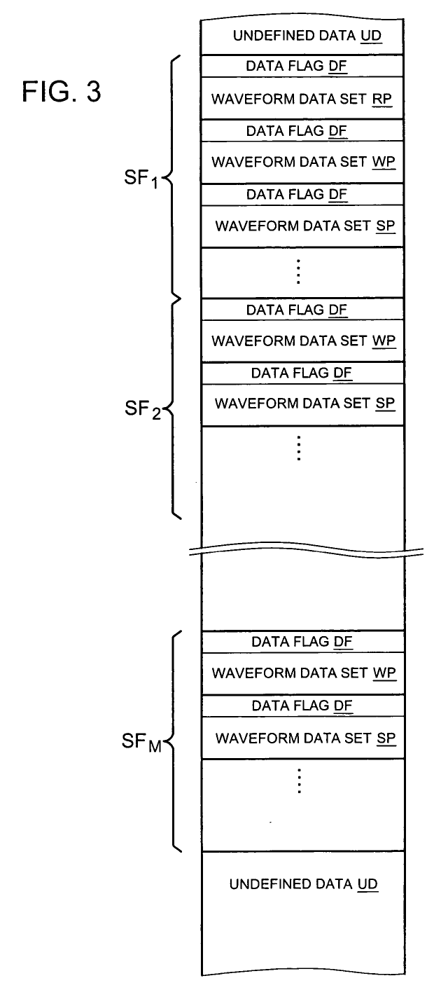

The controller 21 includes a circuit group comprised of microcomputer (control section) 30, memory 31 which is a non-volatile memory, and a signal output circuit 32, as a sequence control circuit for controlling the above mentioned drive sequence for light emission. The memory 31 has storage areas shown in FIG. 3, and stores a plurality of types of data sets for drive pulses to be applied in each of the subfields SF₁-SF_{M}. For example, a waveform data set RP for the reset pulses, a waveform data set WP for the address pulses and a waveform data sets SP for the discharge sustain pulses are stored as waveform data sets corresponding to the subfield SF₁. Also as waveform data sets corresponding to the subfield SF₂, a waveform data set WP for the address pulses and a waveform data sets SP for the discharge sustain pulses are stored. Data flags DF are attached to the corresponding waveform data sets RP, WP, SP, . . . , each data flag DF indicating whether the corresponding waveform data set is valid. In the storage areas that should not be used for sequence control, undefined data UD is stored.

The microcomputer 30 supplies the address data AD to the memory 31 in synchronization with the vertical synchronization signal and clock signal, and also supplies a signal IS to which the signal output circuit 32 responds by generating control signals causing the address electrode driver 16 and sustain electrode drivers 17A and 17B to generate drive pulses. Responding to this, the memory 31 reads the data set DS and the corresponding data flag DF from the storage area specified by address data AD, and supplies these data set and data flag to the signal output circuit 32. The signal output circuit 32 generates the control signals based on the data set DS, and supplies these control signals to the address electrode driver 16 and the sustain electrode drivers 17A and 17B respectively.

The signal output circuit 32 generates an operation flag OF that indicates its own operation status, and supplies this operation flag OF to the microcomputer 30. The operation flag OF has either the value “0” or “1.” The value “1” of the operation flag OF indicates that the signal output circuit 32 is in operation status, and the value “0” of the operation flag OF indicates that the signal output circuit 32 is in non-operation status. The microcomputer 30 monitors this operation flag OF at a predetermined interval or in real-time. For example, when the operation flag OF successively has “1” for a period exceeding one cycle of the vertical synchronization signal (i.e., exceeding a vertical synchronization period), that is, when the signal output circuit 32 successively generates control signals for a period exceeding the vertical synchronization period, the microcomputer 30 stops output of the signal output circuit 32.

The signal output circuit 32 returns the data flag value DFS is either “0” or “1” depending on the status indicated by the data flag DF read from the memory 31, to the microcomputer 30. The microcomputer 30 monitors the data flag value DFS at a predetermined interval or in real-time. The microcomputer 30 determines that the data set DS is valid if the data flag value DFS is “1,” and masks the vertical synchronization signals during the period when the data flag value DFS is “1.” The microcomputer 30 determines that the data set DS is not valid if the data flag value DFS is “0,” and stops the supply of the control signals to the signal output circuit 32.

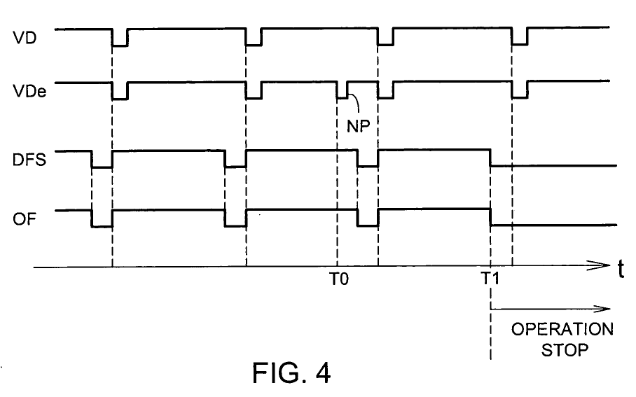

FIG. 4 is a timing chart illustrating an operation of the sequence control circuit. Referring to the timing chart, the vertical synchronization signals VD, VDe, data flag value DFS and operation flag OF are illustrated. The signal level indicating the data flag value DFS becomes a low level or a high level in response to the corresponding data flag value DFS of “0” or “1.” The signal level indicating the operation flag OF becomes a low level or a high level in response to the corresponding value “0” or “1” of the operation flag OF.

When normally executing the drive sequence control of light emission, the microcomputer 30 reads the data set DS and data flag DF from the memory 31 in response to the falling edge of the vertical synchronization signal VD. When the data flag value DFS changes from “1” to “0,” the microcomputer 30 issues instruction IS to the signal output circuit 32 to stop the supply of control signals. When the data flag value DFS changes from “0” to “1,” the microcomputer 30 issues instruction IS to the signal output circuit 32 to enable the output of control signals. Therefore the signal output circuit 32 supplies the operation flag OF having the value of “1” (high level) during the period when the data flag value DFS is “1,” and the signal output circuit 32 supplies the operation flag OF having the value of “0” (low level) during the period when the data flag value DFS is “0.”

Even when the microcomputer 30 receives the vertical synchronization signal VDe including a deformed false pulse NP generated due to an error factor such as noise (at time T0), a malfunction to the microcomputer 30 due to the false pulse NP can be prevented since the vertical synchronization signal VDe is masked during the period when the data flag value DFS is “1.”

During the period when the data flag value DFS becomes “0” after time T1, the microcomputer 30 issues instruction IS to the signal output circuit 32 to stop output of the control signals, in other words, stops the operation of the signal output circuit 32. Therefore, even when undefined data is read from the memory 31, the address electrode driver 16 and the sustain electrode drivers 17A and 17B can be protected from the malfunction of the signal output circuit 32 due to the undefined data.

As described above, the image display device of the above embodiment generates the drive pulses having the type of waveform defined by the data set DS read from the memory 31, unless determining that the data set DS is not valid based on the data flag DF. Therefore, the image display device is capable of preventing malfunction of drive sequence control of light emission to enable stable control.

In the above embodiment, the data flag DF is attached to each of all the waveform data sets as preferred aspects, no limitation thereto intended in the present invention. One data flag DF can be attached to a predetermined number of waveform data sets, for example, or one data flag DF can be attached to a plurality of waveform data sets for each subfield.

It is understood that the foregoing description and accompanying drawings set forth the preferred embodiments of the invention at the present time. Various modifications, additions and alternatives will, of course, become apparent to those skilled in the art in light of the foregoing teaching about departing from the spirit and scope of the disclosed invention. Thus it should be appreciated that the invention is not limited to the disclosed embodiments, but may be practiced within the full scope of the appended Claims.

This application is based on Japanese Patent Application No. 2005-102775 which is hereby incorporated by reference.

What is claimed is:

1. An image display device comprising:
a drive pulse generation circuit for generating drive pulses having a plurality of different types of waveforms in synchronization with a synchronization signal corresponding to an image signal;
a display panel including a plurality of display cells, each display cell emitting light in response to the drive pulses;
a memory for storing a plurality of data sets and the corresponding data flags;
a control section for reading the data set and the corresponding data flag from said memory in synchronization with the synchronization signal, and determining whether the data set read from said memory is valid based on the corresponding data flag; and
a signal output section for supplying a control signal causing said drive pulse generation circuit to generate the drive pulse having the type of waveform defined by the data set read from said memory, unless said control section determines that the data set is not valid.

2. The image display device according to claim 1, wherein, when determining that the data set is not valid, said control section causes said signal output section to stop the supply of the control signal.

3. The image display device according to claim 1, wherein said control section masks the synchronization signal during a period of time when said control section determines that the data set is valid.

4. The image display device according to claim 1, wherein said display panel is a plasma display panel.
